(19) United States
(12) Patent Application Publication
(10) Pub. No.: US 2005/0198284 A1
(43) Pub. Date: Sep. 8, 2005

(54) Method to enable secure cross firewall printing with minimal infrastructure impact

(76) Inventors: Jeremy Bunn, Kelso, WA (US); Jeff M. Anderson, Camas, WA (US); Shell Simpson, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/763,516

(22) Filed: Jan. 23, 2004

(51) Int. Cl. G06F 15/173; G06F 12/14; G06F 11/30

(52) U.S. Cl. 709/225; 713/201

(57) ABSTRACT

A computer-readable medium has a program available thereon for causing a suitably programmed information-handling system to detect the presence of a print job, and post the print job at a selected rendezvous point.

### FIELD OF THE INVENTION

The present invention relates to a method and apparatus for printing documents across a firewall with minimal infrastructure impact.

### BACKGROUND OF THE INVENTION

Many times mobile computer users are visiting a site that has printers that are protected by a firewall associated with the site. The mobile computer user may be an independent consultant, from a different company, or may be from a different office of the same company. Many times there is a need for the mobile user to print content from behind a first firewall to printers that are behind a second firewall associated with the site the mobile user is visiting. Generally, the Information Technology (IT) Professionals who maintain the network at the site and who maintain the firewall around the site are reluctant to open ports to allow a guest, such as the visiting mobile user, to print to printers attached to the network of the site. There are several reasons for the reluctance of IT Professionals. Most notably, when a port has been opened to allow printing there is a substantial security risk. Generally, the risk outweighs any perceived benefit for the site visited. In addition, opening and closing ports or “poking holes” in the firewall takes time and there is always the possibility that one may not be properly closed thereby leaving the network system firewall a bit more exposed.

One method used to print through a firewall is to attach the print job to an electronic mail (e-mail) message. The E-mail message and the attached print job are then sent through the firewall. The print job is then detached from the e-mail message and printed. One problem with using this E-mail method is that the mobile user/print client often does not know anything about the printer or imaging apparatus to which the job will be sent. In addition, the client has no means of readily discovering information about the printer. Thus, the mobile user/print client cannot easily determine the capabilities of the printer or which driver should be used for the printer. Additionally, even if the mobile user/print client could determine the appropriate print driver, the mobile user/print client may not have the correct driver for the printer. This would require loading the printer driver onto the mobile user/print client's computer. In some instances, the mobile user/print client may not even have access to the correct driver for the printer. Still another problem with the E-mail method is that potentially sensitive content is sent to the printer unencrypted. Thus, the mobile user/printer client's information may be exposed to a security risk.

### BRIEF DESCRIPTION OF THE DRAWINGS

The invention is pointed out with particularity in the appended claims. However, a more complete understanding of the present invention may be derived by referring to the detailed description when considered in connection with the figures, wherein like reference numbers refer to similar items throughout the figures and:

FIG. 1 is a schematic diagram of a secure cross firewall imaging system, according to an embodiment of this invention.

FIG. 2 is a schematic diagram of a secure cross firewall imaging system, according to another embodiment of this invention.

FIG. 3 is a schematic diagram of a secure cross firewall imaging system, according to yet another embodiment of this invention.

FIG. 4 shows a flow diagram of a method for printing a print job according to an embodiment of this invention.

FIG. 5 is a schematic side view of a multi-functional imaging apparatus, according to an embodiment of this invention.

FIG. 6 is a functional block diagram of the embodiment shown in FIG. 2, according to an embodiment of this invention.

FIG. 7 is a schematic diagram of an electronic device that includes a computer system, according to an embodiment of this invention.

FIG. 8 is a block diagram of a computer readable medium that includes an instruction set, according to an embodiment of this invention.

### DETAILED DESCRIPTION OF THE INVENTION

The following description and the drawings illustrate specific embodiments of the invention sufficiently to enable those skilled in the art to practice it. Other embodiments may incorporate structural, logical, electrical, process, and other changes. Examples merely typify possible variations. Individual components and functions are optional unless explicitly required, and the sequence of operations may vary. Portions and features of some embodiments may be included in or substituted for those of others. The scope of the invention encompasses the full ambit of the claims and all available equivalents. The following description is, therefore, not to be taken in a limited sense, and the scope of the present invention is defined by the appended claims.

The functions described herein are implemented in software in one embodiment, where the software comprises computer executable instructions stored on computer readable media such as memory or other type of storage devices. The term “computer readable media” is also used to represent carrier waves on which the software is transmitted. Further, such functions correspond to modules, which are software, hardware, firmware of any combination thereof. Multiple functions are performed in one or more modules as desired, and the embodiments described are merely examples.

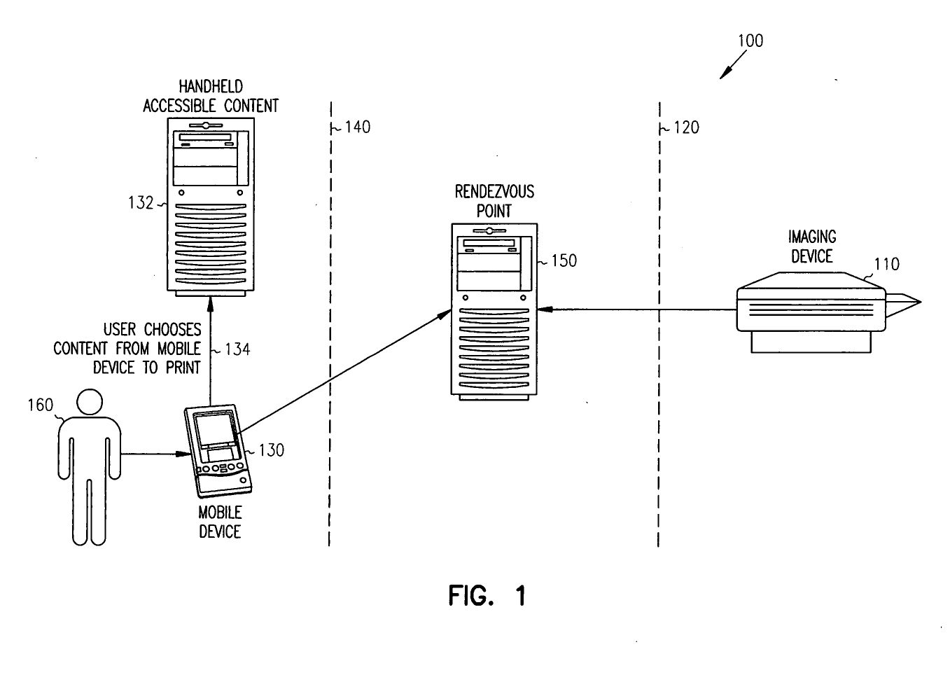

FIG. 1 is a schematic diagram of a secure cross firewall imaging system 100, according to an embodiment of the invention. The secure cross firewall imaging system 100 includes an imaging device 110 positioned behind a first firewall 120 and a mobile device 130, which is positioned behind a second firewall 140. The mobile device 130 can be any type of mobile device including a hand-held computer, a laptop computer, a personal data assistant (PDA), a cellular phone or any similar device. The mobile device 130 is attached to a source of data 132. For example, a hand-held microcomputer, or PDA, can be part of a network that includes a data server or content server 132. In other words, the mobile device 130 and the content server 132 are a part of a second network 134 that is positioned behind the second firewall 140. The imaging device 110 can also be part of a network that is behind the first firewall 120.

The secure cross firewall imaging system 100 includes a rendezvous point 150, which is positioned outside of the first firewall 120 and the second firewall 140. Mobile device user 160 having a mobile device 130 can be positioned behind a second firewall 140, no matter where the user is located. When the mobile user 160 wants to print to a device such as the imaging apparatus 110 behind the first firewall 120, the user chooses or selects content from the content server 132 via the mobile device 130. The network 134 to which the content server 132 and the mobile device 130 are attached forms a print job and sends it to the rendezvous point 150. In another embodiment, the content server 132 forwards the content to be printed to the rendezvous point 150. At the rendezvous point 150, a print job is created.

The imaging apparatus 110, or the network to which the printing apparatus is attached, polls the rendezvous point 150 to determine or detect if there is a print job at the rendezvous point 150. If there is a print job at the rendezvous point 150, the network or the imaging device 110 retrieves the print job from the rendezvous point 150. In one embodiment, retrieving and sending the print job from and to the rendezvous point 150 is done using a secure protocol. There are several types of secure protocols available, such as HTTPS or SSL. In other embodiments of the invention, the data from the network 134 is placed at the rendezvous point 150 using a secure protocol and the print job formed at the rendezvous point 150 is retrieved using a secure protocol. The rendezvous point 150, as shown in FIG. 1, is a hardware device. The rendezvous point is identified using a universal resource locator (URL).

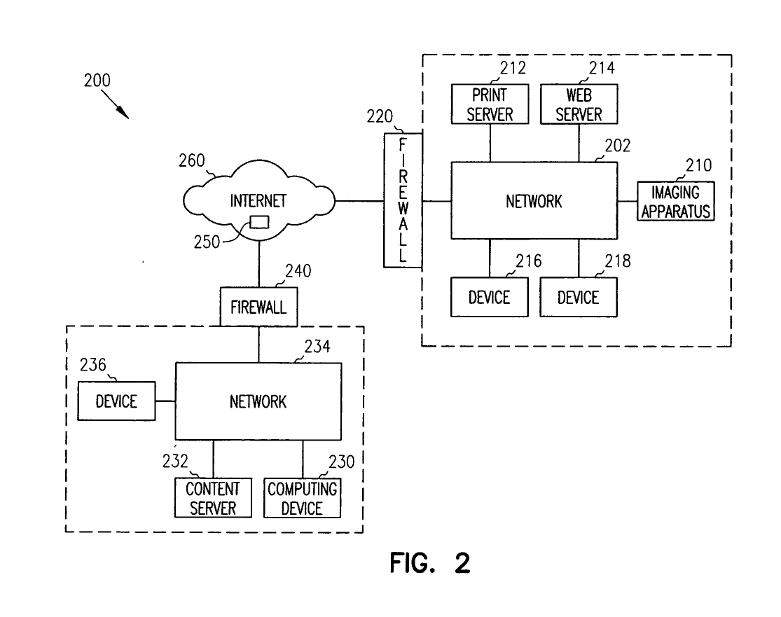

FIG. 2 is a schematic diagram of a secure cross firewall imaging system 200, according to another embodiment of this invention. As shown in FIG. 2, the secure cross firewall imaging system 200 includes a first network 202 located behind a first firewall 220 and a second network 234 positioned behind and protected by a second firewall 240. The first network 202 includes a print server 212, a web server 214, and a first other device 216, and a second other device 218. The second network 234 includes a content server 232, a computing device 230, and another device 236. The second network 234, as well as the first network 202, are attached to the Internet 260. The Internet 260 is a third network. The Internet is a global informational network that links a very substantial fraction of the world's computer networks. The Internet 260 includes a rendezvous point 250. The rendezvous point 250 is hosted by a machine connected to the public Internet that is accessible from both devices connected to network 234 and devices connected to network 202. The rendezvous point 250 is located outside the first firewall 240 and outside the second firewall 240. It should be noted that the rendezvous point 250, identified by a URL, can be hosted physically on a device on network 202 or on network 234 but is, importantly, accessible from points outside the firewall 220 of the first network 202 and points outside the firewall 240 of the second network 234.

In operation, a computing device 230 is used to select content from a content server 232 to send to the Internet and specifically to send to the rendezvous point 250 that is specified by a URL that refers to a location on the Internet 260. The network 234 uses a protocol to send either data or data in the form of a print job to the rendezvous point 250 which may be specified using a URL referring to a location on the public Internet 260. In one embodiment a secure protocol, such as HTTPS or SSL, is used to securely send the print job or data that is to be formed into a print job to the address specified by the rendezvous point 250. The first network 202, or device on the first network 202, queries or polls the rendezvous point 250 to determine if there is data or data in the form of a print job at the rendezvous point 250. If there is data that is to be a print job or a print job located at the rendezvous point 250, the network 202 uses a protocol and retrieves the data from the rendezvous point 250. Once the data is retrieved from the rendezvous point 250 it is routed by the network 202 or by print server 212 attached to the network to an imaging apparatus or the imaging apparatus 210. The protocol used between the network 202 and the rendezvous point 250, identified and locatable by a URL, on the Internet 260 is a secure connection such as HTTPS or SSL. It should be noted that the channel or interconnection between the network 234 and the rendezvous point 250 as well as the interconnection or channel between the network 202 and the rendezvous point 250 does not necessarily have to be a secure connection and can be a regular HTTP connection, a file transfer protocol (FTP) connection, or an anonymous FTP connection or similar connection. There is a distinct advantage if the connection is secure since the content of the data is much less likely to be corrupted or detected when sent over a secure channel.

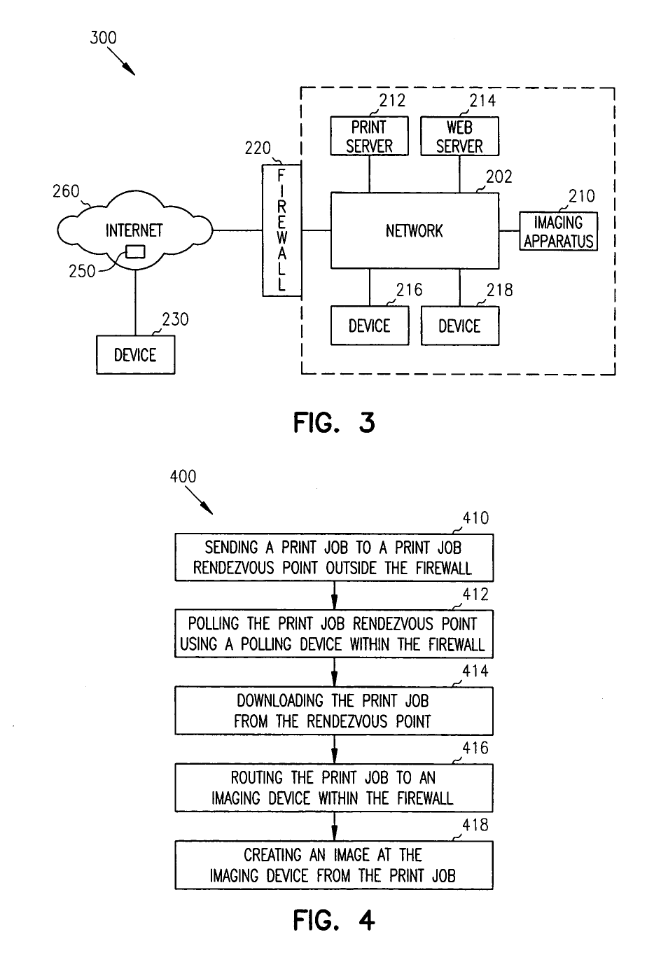

FIG. 3 is a schematic diagram of a secure cross firewall imaging system 300, according to yet another embodiment of this invention. In this particular embodiment, device 230 is attached to the Internet 260 and includes content to be printed. The device 230 can be attached to the Internet 260 using a dial-up connection, a DSL line, or similar connection to the Internet. The device 230 places content at the rendezvous point 250. The network 202, or more specifically, a device associated with the network such as a web server 214, polls the rendezvous point 250 and pulls or causes the data or print job at the rendezvous point 250 to be transmitted from the rendezvous point 250 to the network 202.

FIG. 4 shows a flow diagram of a method 400 of printing a print job from a device 230 (FIGS. 2 and 3) outside a firewall 220 at an imaging device 110, 210 (FIGS. 1-3) behind a firewall 220. The method 400 includes sending a print job to a print job rendezvous point outside the firewall 410, polling the print job rendezvous point using a polling device within the firewall 412, and downloading the print job from the print job rendezvous point 414. The method also includes routing the print job to an imaging device within the firewall 416, and creating an image at the imaging device from the print job 418. In one embodiment, the print job rendezvous point is specified by a universal resource location (URL). The method 400 also includes encrypting the print job and decrypting the print job before creating the image at the imaging device. In some embodiments, sending the print job 410 to the job rendezvous point and downloading the print job from the print job rendezvous point 414 uses a secure protocol. The secure protocol is a secure sockets layer (SSL) protocol or secure hypertext transfer protocol (HTTPS) or any other secure protocol. In some instances, sending the print job to the job rendezvous point 410 and downloading the print job from the print job rendezvous point 414 uses file transfer protocol (FTP). Sending a print job to a print job rendezvous point 410 can include posting the print job to a location specified by a universal resource location. The imaging device 110, 210 is attached to a network 202 behind a firewall 220 and polls the rendezvous point 250.

It should be noted that the invention also includes the hardware shown in FIGS. 1-3. For example, a system for handling a print job includes a network 202 having an imaging device 210 attached to the network 202, and another device 216 attached to the network 202. A firewall 220 is positioned with respect to the network 202 to reduce the risk of undesirable access to the network 202 from locations outside the network 202. A rendezvous point 250 is positioned outside the firewall 220. The imaging device 210 or another device 214 polls the rendezvous point 250 to determine if a print job is located at the rendezvous point. The system also includes an apparatus for transmitting the print job from the rendezvous point into the network and providing the print job to the imaging apparatus 210 on the network 202. In some embodiments of the system, the imaging apparatus 210 includes an embedded web server, which will be explained in further detail below. The rendezvous point 250 can be specified by a universal resource location (URL). The apparatus for transmitting the print job from the rendezvous point 250 into the network uses a secure protocol, such as secure hypertext transfer protocol (HTTPS) or secure socket layer (SSL) protocol. The imaging device 210 or another device polls the rendezvous point periodically.

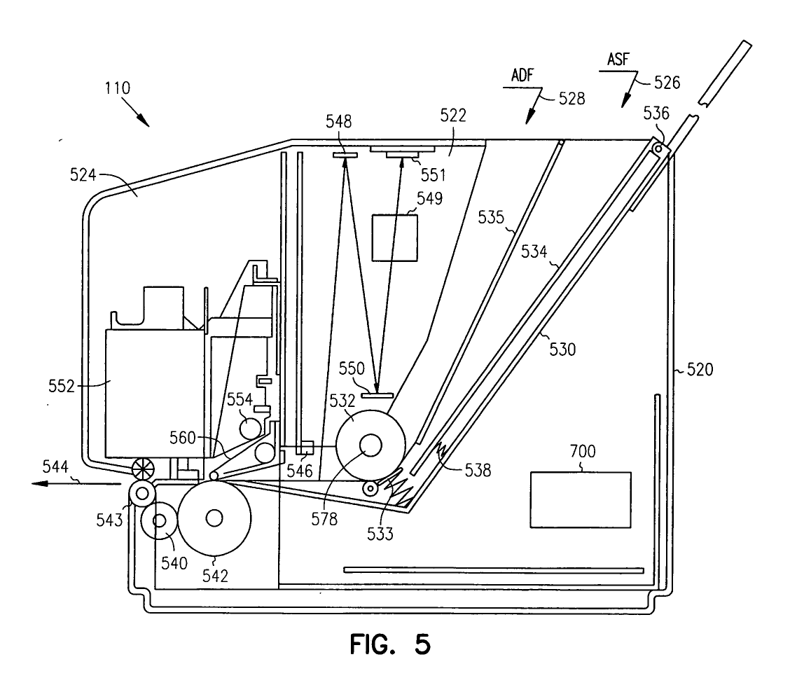

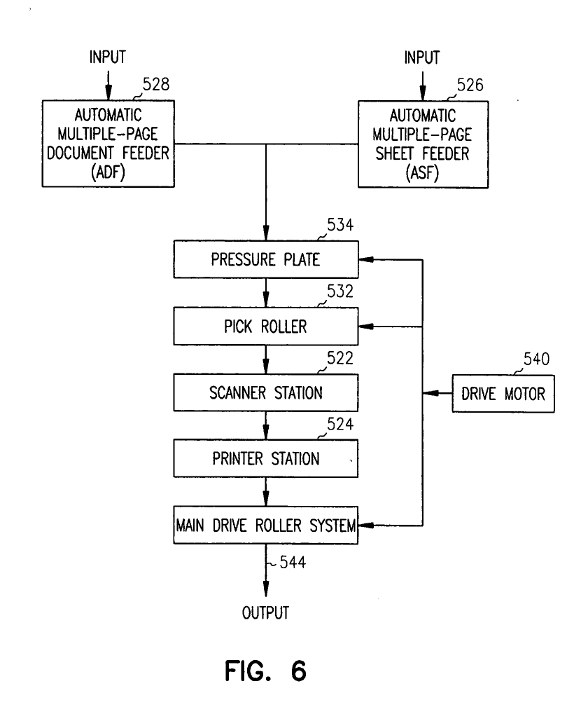

Now referring to both FIGS. 5 and 6, an imaging apparatus 110 will be described. The imaging apparatus 110 is a multiple-function imaging apparatus that includes a frame 520 for housing a scanner station 522 and a printer station 524. A stack of print sheets is loadable into an automatic sheet feeder (ASF) 526, and a stack of documents having text/graphics to be scanned is loadable into an automatic document feeder (ADF) 528 which together form a common input feeder slot 530 having a pick roller 532 and a spring-loaded stripper pad 533 at the lower end. The upper portion of the input feeder slot that constitutes the ADF is separated from the ASF by a divider 535. The divider 535 is truncated at the lower end to allow document stacks and sheets stacks to converge at the pick roller 578. A pressure plate 534 is attached at its upper end through pivot pin 536 to the frame and is normally biased upwardly against the pick roller by springs 538. A drive motor 540 is connected through a gear mechanism to the pressure plate 534 and pick roller 532 and is also connected to a main drive roller 542 which pulls the pages through the processing stations (i.e. either the scanning station 522 or printing station 524. The printout pages, as well as the scanned, pages pass across an output roller 543 to be deposited in a common output area 544.

The scanner station 522 includes a lamp 546 for illuminating a scanning zone, reflective mirrors 548, 550, a lens 549, and a CCD (charge-coupled device) photosensor 551. Printer station 524 includes inkjet cartridge 552 that rides on a slider rod 554 back and forth across a print zone 560.

The multi-functional imaging apparatus 200 also includes an electronic device 700 also known as an information handling system. The electronic device 700 or information handling system includes all devices capable of handling information, including but not limited a dedicated micro-controller, a microprocessor or a computer. The electronic device 700 generally controls the hardware within the multi-function imaging apparatus 110, the tasks of the multi-function imaging apparatus 110, and the communications between the multi-function imaging apparatus 110 and the networks 202 (FIG. 2) which the multi-function imaging apparatus is communicatively coupled and other networks the network 202 can be a local area network, a wide area network, or the like. The network 202 may also be attached to other LANS, WANS, or the Internet.

It should be noted that the imaging apparatus need not be a multi-function imaging apparatus, as described. The imaging apparatus could be a printer, a scanner capable of outputting files in different formats or other imaging devices. The imaging device can have one function or multiple functions and still be within the scope of this invention. The imaging device includes an electronic device 700.

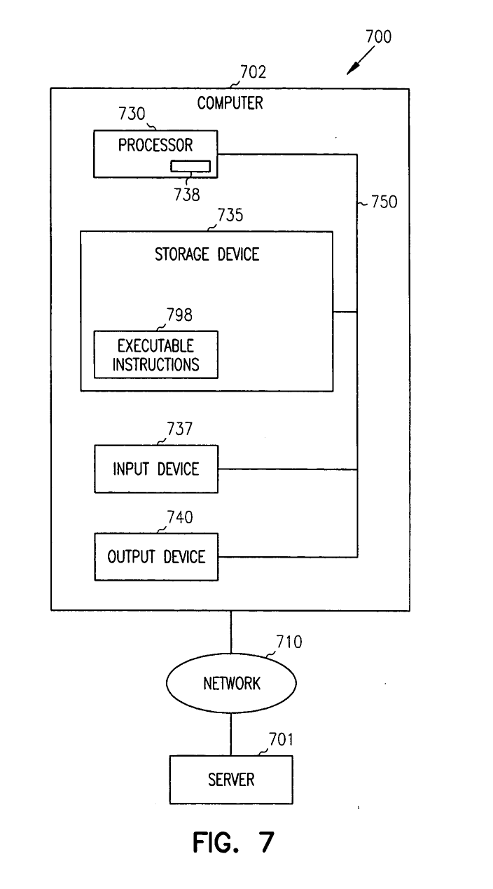

FIG. 7 is a schematic diagram of the electronic device 700. The electronic device 700 includes a computer system 702, according to an embodiment of this invention. The computer system 702 includes a processor 730 and a storage device 735. The storage device 735 includes executable instructions 798. The executable instructions 798 are stored within the storage device 735. The electronic device 700 can include a network 710 and a print server 701. The network 710 can correspond to network 202 (shown in FIG. 2) and server 701 can correspond to print server 212 (shown in FIG. 2). The computer 702 is communicatively coupled to the network 202. The network 202 and the computer 702 are communicatively coupled to the print server 212.

The processor 730 represents a central processing unit of any type of architecture, such as a CISC (Complex Instruction Set Computing), RISC (Reduced Instruction Set Computing), VLIW (Very Long Instruction Word), or hybrid architecture, although any appropriate processor may be used. The processor 730 executes instructions and includes that portion of the electronic device 700 that controls the operation of the entire electronic device 700. The processor 730 also includes a control unit 738 that organizes data and program storage in memory and transfers data and other information between the various parts of the electronic device 700. The processor 730 receives input data from the input device 737 and the network 710, reads and stores code and data in the storage device 735, and presents data to an output device 740 and/or the network 710.

Although the electronic device 700 is shown to contain only a single processor 730 and a single bus 750, the present invention applies equally to electronic devices that may have multiple processors and multiple buses with some or all performing different functions in different ways.

The storage device 735 represents one or more mechanisms for storing data. For example, the storage device 735 may include read only memory (ROM), random access memory (RAM), magnetic disk storage media, optical storage media, flash memory devices, and/or other machine-readable media. In other embodiments, any appropriate type of storage device may be used. Although only one storage device 735 is shown, multiple storage devices and multiple types of storage devices may be present, and in various embodiments some or all of the product codes, the controller 738, and the products may be stored on the same or on different storage devices. Further, although the electronic device 700 is drawn to contain the storage device 735, it may be distributed across other electronic devices, for example on computers attached to the network 710.

The controller 738 includes instructions capable of being executed on the processor 730 to carry out the functions of the present invention. In another embodiment, some or all of the functions of the present invention are carried out via hardware in lieu of a processor-based system.

The input device 737 may be a keyboard, mouse or other pointing device, trackball, touchpad, touchscreen, keypad, microphone, voice recognition device, or any other appropriate mechanism for the user to input data to the electronic device 700. Although one input device 737 is shown, in another embodiment any number (including none) and type of input devices may be present.

The output device 740 is that part of the electronic device 700 that communicates output to the user. The output device 740 may be a cathode-ray tube (CRT) based video display well known in the art of computer hardware. But, in other embodiments the output device 740 may be replaced with a liquid crystal display (LCD) based or gas, plasma-based, flat-panel display. In another embodiment, the output device 740 may be a speaker. In still other embodiments, any appropriate output device may be used. Although one output device 740 is shown, in other embodiments, any number (including none) of output devices of different types or of the same type may be present. In one embodiment, the output device is part of the printer 760. In another embodiment, the output device is a separate, stand-alone device.

The bus 750 may represent one or more busses, e.g., PCI, ISA (Industry Standard Architecture), X-Bus, EISA (Extended Industry Standard Architecture), or any other appropriate bus and/or bridge (also called a bus controller).

The electronic device 700 may be implemented using any suitable hardware and/or software, such as a personal computer. Portable computers, laptop or notebook computers, PDAs (Personal Digital Assistants), pocket computers, telephones, pagers, appliances, and mainframe computers are examples of other possible configurations of the electronic device 700. The hardware and software depicted in FIG. 7 may vary for specific applications and may include more or fewer elements than those depicted. For example, other peripheral devices such as audio or chip programming devices, such as EPROM (Erasable Programmable Read-Only Memory) programming devices may be used in addition to or in place of the hardware already depicted.

The network 710 or 202 (shown in FIG. 2) may be any suitable network and may support any appropriate protocol suitable for communication between the electronic device 700 and the imaging apparatus 110 (FIG. 1), 210 or other electronic devices. In an embodiment, the network 710 or 202 may support wireless communications. In another embodiment, the network 710 or 202 may support hard-wired communications, such as a telephone line or cable. In another embodiment, the network 710 or 202 may support the Ethernet IEEE (Institute of Electrical and Electronics Engineers) 802.3x specification. In another embodiment, the network 410 may be the Internet and may support IP (Internet Protocol). In another embodiment, the network 710 or 202 may be a local area network (LAN) or a wide area network (WAN). In another embodiment, the network 710 or 202 may be a hotspot service provider network. In another embodiment, the network 710 or 202 may be an intranet. In another embodiment, the network 710 or 202 may be a GPRS (General Packet Radio Service) network. In another embodiment, the network 710 or 202 may be any appropriate cellular data network or cell-based radio network technology. In another embodiment, the network 710 or 202 may be a wireless network. In still another embodiment, the network 710 or 202 may be any suitable network or combination of networks. Although one network 710 or 202 is shown, in other embodiments any number of networks (of the same or different types) may be present.

Aspects of an embodiment pertain to specific apparatus and method elements implementable on a computer or other electronic device. In another embodiment, the invention may be implemented as a program product for use with an electronic device. The programs defining the functions of this embodiment may be delivered to an electronic device via a variety of signal-bearing media, which include, but are not limited to:
(1) information permanently stored on a non-rewriteable storage medium, e.g., a read-only memory device attached to or within an electronic device, such as a CD-ROM readable by a CD-ROM drive;
(2) alterable information stored on a rewriteable storage medium, e.g., a hard disk drive or diskette; or
(3) information conveyed to an electronic device by a communications medium, such as through a computer or a telephone network, including wireless communications.

Such signal-bearing media, when carrying machine-readable instructions that direct the functions of the present invention, represent embodiments of the present invention.

An imaging apparatus includes a processor 730, a storage device 735, and software operable on the processor 730. The software causes the processor 730 to poll a rendezvous point, detect the presence of a print job at the rendezvous point 150, 250 (shown in FIGS. 1 and 2, respectively), initiate transmission of the print job from the rendezvous point to the imaging apparatus 110, 210 (shown in FIGS. 1 and 2, respectively), and form an image from the information in the print job. The software is further operable on the processor to decrypt the image of a copy of an original document using a public key of a person sending the document, and print a copy of the image original document at the system of the recipient. The storage device of the imaging apparatus stores an image of the original document until an indication that the transmitted document is received. The software is further operable on the processor to poll another imaging apparatus to which the image of the original document is transmitted to determine if the other imaging device is enabled to receive the transmission of the original document.

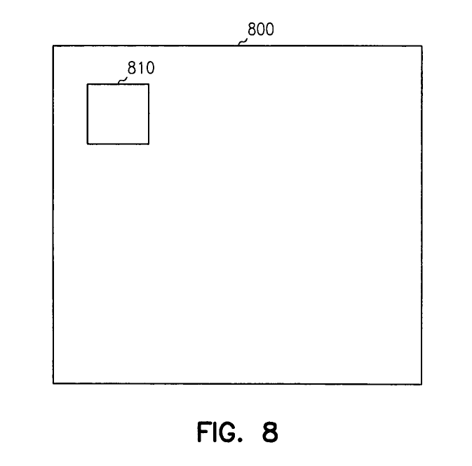

FIG. 8 is a block diagram of a computer readable medium 800 that includes an instruction set 810, thereon. The instruction set 810 can be any set of instructions including a computer program. The computer readable medium can be any computer-readable medium including a storage device or a signal-bearing medium. A computer-usable storage medium having a computer program thereon causes a suitably configured electronic device or information handling system 700 to transport files between a rendezvous point and an imaging device protected by a firewall. The following is performed when the program is executed on the information-handling system: the rendezvous point is checked, the presence of a file at the rendezvous point is detected, and a secure transmission of the file from the rendezvous point to a device within the firewall is initiated. When the file is a print job and the device is an imaging apparatus, the program is further capable of routing the print job to the imaging apparatus, and forming an image from the information in the print job.

In the previous detailed description of exemplary embodiments of the invention, reference was made to the accompanying drawings, which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. Different instances of the word “embodiment” as used within this specification do not necessarily refer to the same embodiment, but they may. The previous detailed description is, therefore, not to be taken in a limiting sense, and the scope of the present invention is defined only by the appended claims.

In the previous description, numerous specific details were set forth to provide a thorough understanding of the invention. However, it is understood that the invention may be practiced without these specific details. In other instances, well-known circuits, structures, and techniques have not been shown in detail in order not to obscure the invention.

Although specific embodiments have been illustrated and described herein, those of ordinary skill in the art will appreciate that any arrangement calculated to achieve the same purpose can be substituted for the specific embodiments shown. This disclosure is intended to cover any and all adaptations or variations of various embodiments of the invention. It is to be understood that the above description has been made in an illustrative fashion, and not a restrictive one. Combinations of the above embodiments, and other embodiments not specifically described herein will be apparent to those of skill in the art upon reviewing the above description. The scope of various embodiments of the invention includes any other applications in which the above structures and methods are used. Therefore, the scope of various embodiments of the invention should be determined with reference to the appended claims, along with the full range of equivalents to which such claims are entitled.

It is emphasized that the Abstract is provided to comply with 37 C.F.R. § 1.72(b) requiring an Abstract that will allow the reader to quickly ascertain the nature and gist of the technical disclosure. It is submitted with the understanding that it will not be used to interpret or limit the scope or meaning of the claims.

In the foregoing Description of Embodiments of the Invention, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the Description of Embodiments of the Invention, with each claim standing on its own as a separate preferred embodiment.

1. A method of printing a print job from a device outside a firewall at an imaging device behind a firewall comprising:
sending a print job to a print job rendezvous point outside the firewall;
polling the print job rendezvous point using a polling device within the firewall;
downloading the print job from the print job rendezvous point;
routing the print job to an imaging device within the firewall; and
creating an image at the imaging device from the print job.

2. The method of claim 1 wherein the print job rendezvous point is identified by universal resource location (URL).

3. The method of claim 1 further comprising encrypting the print job.

4. The method of claim 1 further comprising:
encrypting the print job; and
decrypting the print job before creating the image at the imaging device.

5. The method of claim 1 wherein the sending the print job to the job rendezvous point and downloading the print job from the print job rendezvous point uses a secure protocol.

6. The method of claim 5 wherein the secure protocol is a secure sockets layer (SSL) protocol.

7. The method of claim 1 wherein the sending the print job to the job rendezvous point and downloading the print job from the print job rendezvous point uses file transfer protocol (FTP).

8. The method of claim 1 wherein sending a print job to a print job rendezvous point includes the step of posting the print job to a network service addressed by a universal resource location.

9. The method of claim 1 wherein an imaging device attached to a network behind a firewall polls the rendezvous point.

10. A system for handling a print job comprising:
a network further comprising:
an imaging device attached to the network; and
another device attached to the network;
a firewall positioned with respect to the network to reduce the risk of undesirable access to the network from locations outside the network;
a rendezvous point positioned outside to the firewall, wherein one of the imaging device or another device polls the rendezvous point to determine if a print job is located at the rendezvous point.

11. The system of claim 10 further comprising an apparatus for transmitting the print job from the rendezvous point into the network and providing the print job to the imaging apparatus on the network.

12. The system of claim 10 wherein the imaging apparatus includes an embedded web server.

13. The system of claim 10 wherein the rendezvous point is specified by a universal resource location (URL).

14. The system of claim 11 wherein the apparatus for transmitting the print job from the rendezvous point into the network uses a secure protocol.

15. The system of claim 14 wherein the secure protocol is secure hypertext transfer protocol (HTTPS).

16. The system of claim 14 wherein the secure protocol is secure socket layer (SSL) protocol.

17. The system of claim 10 wherein the one of the imaging device or another device polls the rendezvous point periodically.

18. An imaging apparatus comprising:
a processor;
a storage device; and
software operable on the processor to:
poll a rendezvous point;
detect the presence of a print job at the rendezvous point; and
initiate transmission of the print job from the rendezvous point to the imaging apparatus; and
form an image from the information in the print job.

19. The imaging apparatus of claim 18 wherein the software is further operable on the processor to
decrypt the image of a copy of an original document using a public key of a person sending the document; and
print a copy of the image original document at the system of the recipient.

20. The imaging apparatus of claim 18 wherein the storage device stores an image of the original document until an indication that the transmitted document is received.

21. The imaging apparatus of claim 18 wherein the software is further operable on the processor to poll an other imaging apparatus to which the image of the original document is transmitted to determine if the other imaging device is enabled to receive the transmission of the original document.

22. A system for handling a print job comprising:
a first network further comprising:
an imaging device attached to the first network; and
another device attached to the first network;
a second network, the first network coupled to the second network;
a firewall positioned between the first network and the second network, the firewall for reducing the risk of undesirable access to the first network via the second network;
a rendezvous point positioned outside to the firewall, wherein one of the imaging device or another device polls the rendezvous point to determine if a print job is located at the rendezvous point.

23. The system of claim 22 the print job is placed at the rendezvous point using a secure protocol.

24. The system of claim 22 further comprising:
a first secure channel between the first network and the rendezvous point; and
a second secure channel between the second network and the rendezvous point.

25. A computer-readable medium having a program available thereon for causing a suitably programmed information-handling system to transport files between a rendezvous point and an imaging device protected by a firewall by performing the following when the program is executed on the information-handling system:
check the rendezvous point;
detect the presence of a file at the rendezvous point; and
initiate a secure transmission of the file from the rendezvous point to a device within the firewall.

26. The computer-readable medium of claim 25 wherein the file is a print job and wherein the device is an imaging apparatus, the program further capable of
routing the print job to the imaging apparatus; and
forming an image from the information in the print job.

27. A computer-readable medium having a program available thereon for causing a suitably programmed information-handling system to perform the following when the program is executed on the information-handling system:
detects the presence of a print job; and
posts the print job at a selected rendezvous point.

28. The computer-readable medium of claim 27 wherein the program further causes a suitably programmed information-handling system to initiate a secure transmission of the print job to the selected rendezvous point from a device within a firewall when the program is executed on the information-handling system.

29. A computer-readable medium having a program available thereon for causing a suitably programmed information-handling system to perform the following when the program is executed on the information-handling system:
poll a rendezvous point; and
detect the presence of a print job at the rendezvous point.

30. The computer-readable medium of claim 29 wherein the program further causes a suitably programmed information-handling system to initiate a secure transmission of the print job from the rendezvous point to a device within a firewall when the program is executed on the information-handling system.

31. The computer-readable medium of claim 30 wherein the program further causes a suitably programmed information-handling system to:
route the print job to an imaging apparatus; and
form an image from the information in the print job, when the program is executed on the information-handling system.

32. A system for handling a print job comprising:
means for posting the print job at a selected rendezvous point; and
means for detecting the presence of a print job at the rendevous point.

33. The system for handling a print job of claim 32 wherein means for posting the print job at a selected rendezvous point posts the print job outside a firewall.

34. The system for handling a print job of claim 32 further comprising means for initiating a secure transmission of the print job to the selected rendezvous point from a device within a firewall.

34. The system for handling a print job of claim 32 further comprising means for initiating a secure transmission of the print job to retrieve the print job from the selected rendezvous point with a device within a firewall.

35. The system for handling a print job of claim 32 further comprising means for means for polling a selected rendezvous point.
